(19) United States
(12) Patent Application Publication
(10) Pub. No.: US 2005/0094131 A1
(43) Pub. Date: May 5, 2005

(54) Light source apparatus

(75) Inventor: Takehiko Iguchi, Hyogo (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA

(21) Appl. No.: 10/975,949

(22) Filed: Oct. 29, 2004

(30) Foreign Application Priority Data
Oct. 29, 2003 (JP) 2003-369426

(51) Int. Cl. G01J 1/00

(52) U.S. Cl. 356/123

(57) ABSTRACT

In a light source apparatus according to the present invention, variation does not occur depending on an operator, and further it is possible to adjust the position of a discharge lamp even after the light source apparatus is installed in a case. The light source apparatus has a discharge lamp and a reflection mirror which are disposed in a casing, and light emitted from the discharge lamp is condensed by the reflection mirror to an end portion of an integrator lens disposed outside the casing. Further, the light source apparatus comprises a position adjustment unit in which position of the discharge lamp is adjusted so that a target for lamp position adjustment formed on the casing is seen on a virtual line which passes at least one through-hole for inspection provided in the reflection mirror and a portion where a luminescent spot of the discharge lamp is formed.

### FIELD OF THE INVENTION

The present invention relates to a light source apparatus for a digital projector, which is equipped with a high brightness discharge lamp and a reflecting mirror, and in particular, to a light source for digital projector in the image field.

### DESCRIPTION OF THE RELATED ART

A conventional light source apparatus used in the image field has a structure in which a high brightness xenon short arc lamp is used as a light source and a reflecting mirror is combined with the lamp wherein they are accommodated in a casing.

FIG. 5 is a cross sectional view of the conventional light source apparatus which is built in a case to which an integrator lens is attached.

A discharge lamp 52 in which xenon gas is enclosed as a luminescence substance, and a reflection mirror 53 for condensing light emitted from the discharge lamp 52, are provided in a casing 51 of a light source apparatus 50, wherein the light condensed by the reflection mirror 53 passes through an opening portion 510 provided in the casing 51 and is led to an end portion 541 of an integrator lens 54 arranged outside the casing 51. The light source apparatus 50 is built in the casing 55 so as to be removable from the case 55 so that the lamp can be easily replaced. The integrator lens 54 is built in the case 55 outside the casing 51.

A position adjusting unit 502 for moving the discharge lamp 52 in X, Y, and Z axis directions with respect to the reflection mirror 53 which is connected to a support member 501 for supporting the discharge lamp 52, is disposed in the casing 51.

The reflection mirror 53 comprises a light condensing reflection mirror 53a for condensing light emitted from the discharge lamp 52 to the end portion 541 of the integrator lens 54, and a spherical capture reflection mirror 53b for capturing the light which is emitted from the discharge lamp 52 but deviates from the light condensing reflection mirror 53a and for returning the deviating light to the condensing reflection mirror 53a. The light condensing reflection mirror 53a has a first focal point 531 in the side of the light condensing reflection mirror 53a, a second focal point 532 in the side of the integrator lens 54, and an optical axis 500 which passes the first focal point 531 and the second focal 532. In addition, the light condensing reflection mirror 53a is arranged to the discharge lamp 52 so that the position of the first focal point 531 matches the position of a point 523 (located between an anode 521 and a cathode 522 which faces each other in an arc tube 520) where the luminescent spot of the discharge lamp 52 is formed, and is fixed to the casing 51 through the support member so that the position of the second focal point 532 matches the position of the end portion 541 of the integrator lens 54.

In such a light source apparatus 50, in order to use most efficiently the light emitted from the discharge lamp 52, it is necessary to, with sufficient accuracy, match the luminescent spot (luminous point) of the discharge lamp 52 to the first focal point 531 of the light condensing reflecting mirror 53a which is provided in casing 51. Conventionally, the position of the discharge lamp 52 is determined in order to obtain maximum irradiance, by finely adjusting the position with a lamp position adjusting unit 502 provided in the casing 51, by lighting the discharge lamp 52 and measuring screen irradiance in a state where the light source apparatus 50 is disposed in the case 55, wherein the accuracy thereof depends on operator's years of experience and intuition.

### SUMMARY OF THE INVENTION

However, in the conventional lamp position adjusting method, there is a problem that the variation of irradiance is produced depending on an operator's ability, since the accuracy of positioning is greatly dependent on the experience and intuition of the operator. Furthermore, when the case 55 in which the light source apparatus 50 is built is shaken and the position of the discharge lamp 52 shifts so that the irradiance changes, it is very difficult to reproduce the same irradiance as that before the change. Accordingly, as shown in FIG. 6, it is proposed that in such a discharge lamp 52, the positioning of the lamp 52 is carried out before the light source apparatus 50 is built in the case 55.

FIG. 6 is a diagram for explaining how position adjustment of the discharge lamp is carried out before the light source apparatus is built in a case. In FIG. 6, the same reference character numbers as those of FIG. 5 are assigned to the same elements shown in FIG. 5, and description thereof will be omitted.

The light source apparatus 50 is firmly fixed to a light source apparatus support stand 56 so that it may not move easily. A target 57 for adjusting the position of the discharge lamp 12 is arranged outside the light source apparatus 50 so that the target matches the second focal point 532 of the light condensing reflection mirror 53a. This target 57 is fixed to a target support stand 58. The light source apparatus support stand 56 and the target support stand may be integrated. A through-hole 59 for viewing the target 57 is provided at a portion 533 where a virtual line A crosses the light condensing reflection mirror 53a, wherein the virtual line A crosses the optical axis 500 and passes the portion 523 where the luminescent spot of the discharge lamp 52 is formed. In addition, although not illustrated, another through-hole for viewing the target 57 is also provided in the direction of the X axis which is perpendicular to the Y and Z axes.

In the light source apparatus 50, an image of the target 57, which is projected on the other side portion 534 where the virtual line A crosses the light condensing reflection mirror 53a, can be viewed through the through-hole 59 from an inspection hole 511, so that it is possible to adjust the position of the discharge lamp 52 by the position adjusting unit 502. According to such a position adjustment method, since it is possible to carry out position adjustment of the discharge lamp 52 well without relying on the experience and intuition of an operator, so that the variation of irradiance depending on an operator who adjusts the position can be prevented.

However, according to the above-mentioned position adjustment method, the target support stand 58 for supporting the target 57 is required in order to adjust the position of the discharge lamp 52. Therefore, in case that the discharge lamp 52 shifts from the optimal position when the light source apparatus 50 is installed in the case 55, or a shock etc. is given to the case 55 after the light source apparatus is installed in the case 55 so that the discharge lamp 52 shifts from the optimal position thereof, after the light source apparatus 50 is removed from the case 55 and the position adjustment of the discharge lamp 52 is carried out, the discharge lamp 52 is reinstalled in the case 55.

In view of the above problems, it is an object of the present invention to provide a light source in which variation of irradiation does not occurs depending on an operator who adjusts the position of the discharge lamp.

It is another object of the present invention to provide a light source apparatus capable of carrying out the position adjustment of the discharge lamp even after the light source apparatus is installed in a case.

The objects of the present invention is accomplished by a light source apparatus having a discharge lamp, a reflection mirror, wherein the discharge lamp and the reflection mirror are disposed in a casing, and light emitted from the discharge lamp is condensed by the reflection mirror to an end portion of an integrator lens disposed outside the casing, the light source apparatus comprising a position adjustment unit in which position of the discharge lamp is adjusted so that a target for lamp position adjustment formed on the casing is seen on a virtual line which passes at least one through-hole for inspection provided in the reflection mirror and a portion where a luminescent spot of the discharge lamp is formed.

The target may be arranged so that an image of the target is projected on a portion where the virtual line crosses the reflection mirror.

The target may be provided on the virtual line.

In the light source apparatus, at least two or more through-holes may be provided.

In the light source apparatus, at least four or more through holes may be provided.

Further, the objects of the present invention is accomplished by a light source apparatus having a discharge lamp, a reflection mirror, wherein the discharge lamp and the reflection mirror are disposed in a casing, and light emitted from the discharge lamp is condensed by the reflection mirror to an end portion of an integrator lens disposed outside the casing, wherein a target for lamp position adjustment is provided on in the reflection mirror and at least one through hole for inspection is formed in the reflection mirror, and a position adjustment unit in which position of the discharge lamp is adjusted so that the target is seen on a virtual line is provided.

In the light source apparatus according to the present invention, there is no variation of irradiation depending on an operator who adjusts the position of the discharge lamp since it is possible to adjust the position of the discharge lamp by viewing, through a through-hole(s) provided in the reflection mirror, the target for adjusting the discharge lamp position, which is provided on the casing.

Further, it is possible to adjust the position of the discharge lamp in the case when the position of the lamp shifts when the light source apparatus is installed, or in a state where the light source apparatus is installed even when a shock etc. is given to the case after the light source apparatus is installed in the case so that the position of the lamp shifts from the optimal position of the discharge lamp.

### BRIEF DESCRIPTION OF THE DRAWINGS

FIG. 1A shows a cross sectional view of the structure in which a lighting apparatus according to a first embodiment of the present invention is installed in a case to which an integrator is attached;

FIG. 1B a cross sectional view of a lamp and a reflector, taken along a plan face perpendicular to the optical axis 100 and including a virtual line B shown in FIG. 1A;

FIG. 1C is an enlarged view of a portion M shown in FIG. 1A, viewing in the Z axis direction;

FIG. 2A is a cross sectional view of the structure in which a light source apparatus according to a second embodiment of the present invention is installed in a case to which an integrator is attached;

FIG. 2B is a cross sectional view of a lamp and a reflector according to the second embodiment of the present invention, taken along a plan face perpendicular to an optical axis 100 and including a virtual line B shown in FIG. 2A;

FIGS. 3A, 3B, and 3C are an enlarged view of a broken line portion N viewing in the direction of the axis Y shown in FIG. 2A;

FIG. 4A is a cross sectional view of the structure in which a light source apparatus according to a third embodiment of the present invention is installed in a case to which an integrator lens is attached;

FIG. 4B is an enlarged view of a broken line portion O shown in FIG. 4A;

FIG. 5 is a diagram for explaining the structure in which the conventional light source apparatus is built in a casing to which an integrator lens is attached; and

FIG. 6 is a diagram for explaining how position adjustment of the discharge lamp is carried out before the light source apparatus is built in a case.

### DESCRIPTION OF THE PREFERRED EMBODIMENTS

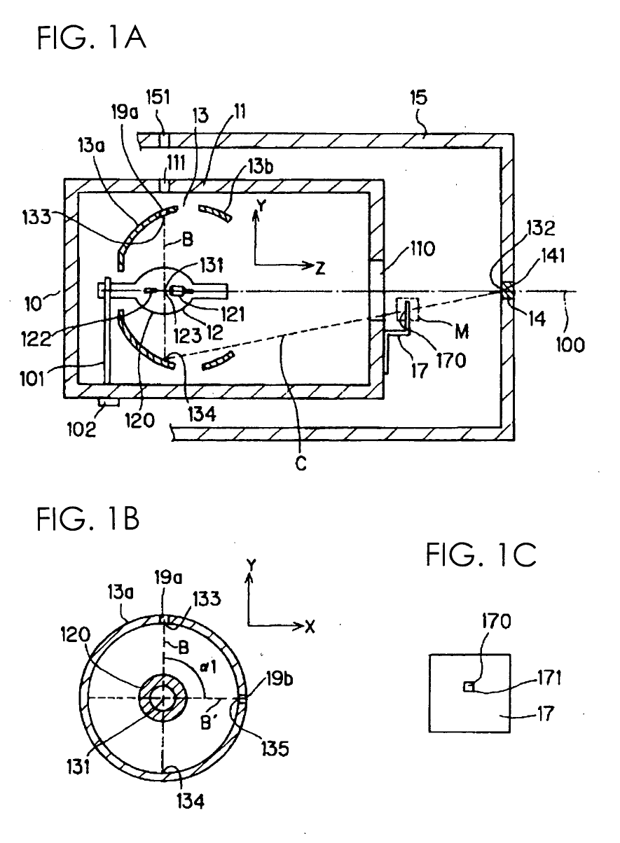

FIGS. 1A, 1B and 1C are diagrams for explaining the structure in which a light source apparatus according to an embodiment of the present invention is installed in a case to which an integrator is attached. FIG. 1A shows a cross sectional view of the lighting apparatus and the case, taken in a longitudinal direction, showing a virtual line B and a broken line portion M. FIG. 1B a cross sectional view taken along a plan face perpendicular to an optical axis 100 and including a virtual line B shown in FIG. 1A. FIG. 1C is an enlarged view of the portion M shown in FIG. 1A, viewing in the Z axis direction.

As shown in FIG. 1A, a discharge lamp 12 in which xenon gas is enclosed as a luminescence substance, and a reflection mirror 13 for condensing light emitted from the discharge lamp 12, are arranged in a casing 11 of the light source apparatus 10, wherein the light condensed by the reflection mirror 13 is led to an end portion 141 of an integrator lens 14 provided outside the casing 11.

The light source apparatus 10 is installed in the case 15 to which the integrator 14 is fixed.

A position adjusting unit 102 for moving the discharge lamp 12 in X, Y, and Z axis directions with respect to the reflection mirror 13 which is connected to a support member 101 for supporting the discharge lamp 12, and a target 17 which is used for adjusting the position of the discharge lamp 12 are disposed in the casing 11.

Moreover, an opening portion 110 for emitting light condensed by the reflection mirror 13 outside the casing 11 is formed in the casing 11, and the light emitted from the opening portion 110 is condensed and irradiated to the end portion 141 of the integrator lens 14. Furthermore, an inspection hole 111 is provided in the casing 11 in order to inspect the target 17 through through-holes 19a and 19b which are described below.

The discharge lamp 12 has the structure in which an anode 121 and a cathode 122 are provided so as to face each other in an arc tube 120, xenon gas is enclosed in the arc tube 120 as a luminescence substance, and both ends of the lamp 12 are sealed.

The reflection mirror 13 comprises a light condensing reflection mirror 13a for condensing light emitted from the discharge lamp 12 to the end portion 141 of the integrator lens 14, and a spherical capture reflection mirror 13b for capturing the light which is emitted from the discharge lamp 12 but deviates from the light condensing reflection mirror 13a and for returning the deviating light to the condensing reflection mirror 13a. The light condensing reflection mirror 13a has a first focal point 131 in the side of the light condensing reflection mirror 13a, a second focal point 132 in the side of the integrator lens 14, and the optical axis 100 which passes the first focal point 131 and the second focal 132. In addition, the light condensing reflection mirror 13a is arranged to the discharge lamp 12 so that the position of the first focal point 131 matches the position of a point 123 (located between the anode 121 and the cathode 122 which faces each other) where the luminescent spot of the discharge lamp 12 is formed, and is fixed to the casing 11 through a support member so that the position of the second focal point 132 matches the position of the end portion 141 of the integrator lens 14. A through-hole 19a for viewing the target 17 is provided at a intersection portion 133 where a virtual line B crosses the light condensing reflection mirror 13a, wherein the virtual line B crosses the optical axis 100 and passes the portion 123 where the luminescent spot of the discharge lamp 12 is formed.

As shown in FIG. 1B, in addition to the through hole 19a shown in FIG. 1A, another through hole 19b is provided in a portion 135 of the light condensing reflection mirror 13a, where a virtual portion B′ crosses the light condensing reflection mirror 13a, wherein the virtual line B′ crosses the virtual line B. That is, these two through holes 19a and 19b are formed in the light condensing reflecting mirror 13a, wherein an angle α1 formed by the virtual line B and the virtual line B′ preferably is 70 to 110 degrees and, more preferably 90 degrees.

Referring back to FIG. 1A, an inspection hole 151 is formed in the case 15 in order to inspect the target 17 through the through hole 19a.

The target 17 is made of, for example, aluminum, wherein, for example, two or more plates are connected so that they can be bent and stretched. That is, the target 17 is folded so as not to block light from the discharge lamp 12, after adjusting the position of the discharge lamp 12. Moreover, the target 17 is arranged so that an image is projected on the other intersection portion 134 where the virtual line B crosses the light condensing reflecting mirror 13a. That is, the target 17 is arranged on a virtual line C wherein the virtual line C crosses the other intersection portion 134 of the light condensing reflection mirror 13a and the second focal point 132, and as shown in FIG. 1C, a mark 171 is formed by, for example, marking-off in an intersecting portion 170 where the virtual line C crosses the target 17. In addition, the mark 171 formed on the target 17 may be formed by placing a component having color different from that of the target 17 thereon. Or, the portion 171 may be formed by a cutout.

Thus, according to the light source apparatus 10 of the first embodiment, the position adjustment of the discharge lamp 12 is carried out by viewing, through the through-hole 19a (and/or 19b) provided in the light condensing reflection mirror 13a, the image of the mark 171 of the target 17, which is projected on the other intersection portion 134, where the virtual line B crosses the light condensing reflection mirror 13a.

Description of a method for adjusting position of the discharge lamp will be given below in detail.

If the discharge lamp 12 is located in the predetermined position when the discharge lamp 12 is viewed through the through-holes 19a and 19b provided in the light condensing reflection mirror 13a while the discharge lamp 12 is turned off, the mark 171 of the target 17 matches the portion 123 where the luminescent spot of a discharge lamp 12 is formed. If the position of the discharge lamp 12 shifts when viewing the inside from the through-hole 19a, the position adjustments in directions of the X and Z axes are carried out by the position adjustment unit 102 provided in the casing 11.

On the other hand, if the position shifts when the inside is viewed from the through-hole 19b, position adjustments in the directions of the Y and Z axes are carried out similarly. In addition, in FIG. 1A, although the structure in which the position adjustment unit 102 is disposed in the outside of the casing 11 is shown, the structure according to the present invention is not limited thereto, the position adjustment unit 102 may be disposed inside the casing 11.

Therefore, in the light source apparatus according to the embodiment of the present invention, it is possible to easily carry out position adjustment of the discharge lamp 12 by anyone, without causing variation of illuminance, and further, it is possible to adjust the position of the discharge lamp 12 when the light source apparatus 10 is installed or in a state where the light source apparatus is installed in the case 15 even when the discharge lamp 12 shifts after the light source apparatus 10 is installed.

In addition, although not illustrated, inspection holes are formed in the direction of X axis in the casing 11 and the case 15.

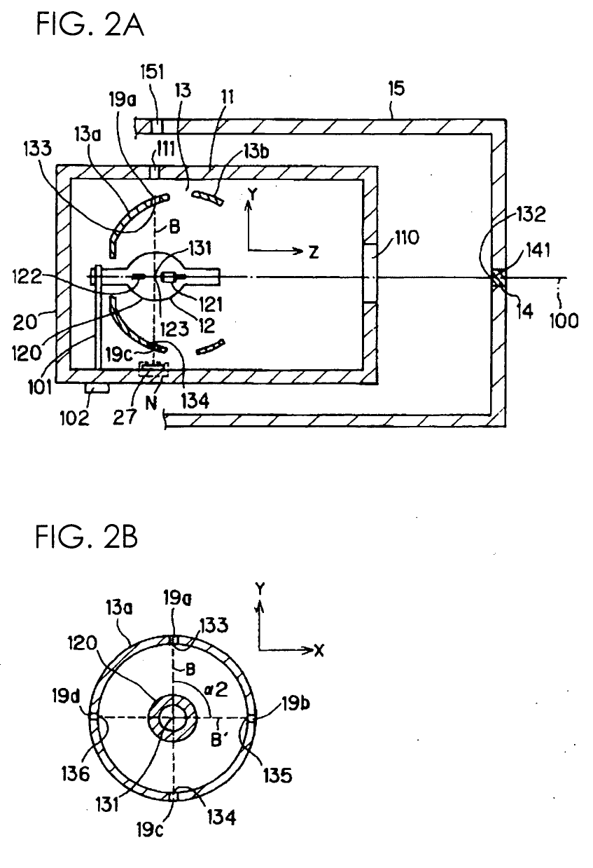

FIGS. 2A and 2B show the structure in which a light source apparatus according to a second embodiment of the present invention, is installed in a case to which an integrator is attached.

FIG. 2A is a cross sectional view of the structure in which a light source apparatus according to a second embodiment of the present invention is installed in a case to which an integrator is attached.

FIG. 2B is a cross sectional view of a lamp and a reflector according to the second embodiment of the present invention, taken along a plan face perpendicular to an optical axis 100 and including a virtual line B shown in FIG. 2A.

In FIG. 2, the same reference character numbers as those of FIG. 1 are assigned to the same elements as those shown in FIG. 1.

As shown in FIG. 2A, in a light source apparatus 20 of the second embodiment of the present invention, through-holes 19a and 19c for inspecting a target 27 are formed respectively in intersection potions 133 and 134 where the virtual line B crosses the light condensing reflection mirror 13a. Furthermore, as shown in FIG. 2B, through-holes 19b and 19d are formed in intersection portions 135 and 136 where the virtual line B′ crosses the light condensing reflection mirror 13a, wherein the virtual line B′ crosses the virtual line B. That is, these four through-holes are formed in the light condensing reflecting mirror 13a, wherein the angle α2 formed by the virtual lines B and B′ is preferably 70 to 110 degrees, and more preferably 90 degrees as well as the first embodiment of the present invention.

The target 27 is disposed on the virtual line B outside the light condensing reflection mirror 13a in the casing 11. The target 27 is made of, for example, aluminum. In addition, although in FIG. 2A, the target 27 is in contact with and fixed to the inner surface of the casing 11, it is not limited thereto, that is, the target 27 may be fixed with respect to the inner surface of the casing without bringing it into contact with it.

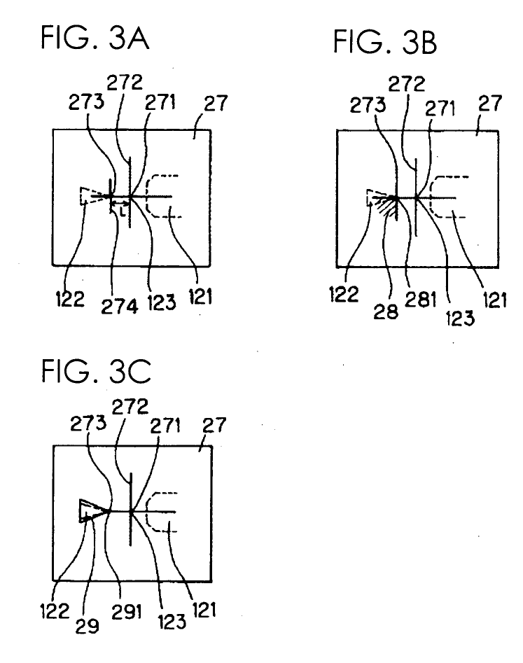

FIGS. 3A, 3B, and 3C are an enlarged view of a broken line portion N viewing in the direction of the axis Y shown in FIG. 2A.

As shown in FIG. 3A, a first mark 272 which is cross-shaped is formed by marking off with a tool wherein the center of the cross is located at a point 271 where the virtual line B crosses the target 27. And the position of the discharge lamp 12 is adjusted so that the center 271 of the cross-shaped first mark 272 matches the luminescent spot of the discharge lamp 12. (The center and the luminescent spot are overlapped.)

However, since the luminescent spot of a discharge lamp 12 is not formed unless it makes a lamp turn on, position adjustment of the discharge lamp 12 in the state where the light is not switched on is specifically performed as set forth below.

In FIG. 2A, when looking through the through-hole 19a provided in the light condensing reflection mirror 13a, the tip of the anode 121 and the tip of the cathode 122 can be seen. Position adjustment of the discharge lamp 12 is desirably carried out by using the cathode 122 having a tower-top-like head. That is, a distance L between the tip portion of the cathode 122 and the portion 123 where the luminescent spot of the discharge lamp 12 is formed, is figured out by calculation beforehand, and in FIG. 3A, the second mark 274 which crosses the first mark 272 at a right angle, is formed at the portion (position) 273 which is located at the distance L from the center 271 of the first mark 272, in the same manner that the first mark 272 is formed. And in case that the position adjustment of the discharge lamp 12 is carried out, the portion 123 where the luminescent spot of the discharge lamp 12 is formed, necessarily overlaps with the center 271 of the first mark 272 when the position of the discharge lamp 12 is adjusted so that the tip portion of the cathode 122 overlaps with the portion (position) 273. In addition, the distance L may be calculated based on the tip portion of the anode 121.

As shown in FIG. 3B, the first mark 272 having a cross shape, on the target 27 by marking off with a tool. And the second mark is formed by attaching a separate component 28 having color different from that of the target 27 to the target 27 so that a corner portion 281 thereof overlaps with the position 273.

As shown in FIG. 3C, the first mark 272 having a cross shape is formed on the target 27 by marking off with a tool. And a notch 29 having an approximately triangle shape is formed in order to form the second mark by hollowing out part of the target 27. The notch 29 is formed so that the tip portion 291 overlaps with the portion (position) 273.

In addition, although, in FIGS. 2A, 2B, 3A, 3B, and 3C, only the position adjustment in the directions of the X and Z axes are described when seeing the inside from the through-hole 19a, position adjustments in the directions of the Y and Z axes can be carried out when seeing the inside from the through-hole 19b in the same manner. That is, a target for adjusting lamp position is also disposed in the direction of the X axis.

Thus, according to the second embodiment of the present invention, in the light source apparatus 20, the position of the discharge lam 12 is adjusted in three dimensional directions (X, Y, and Z axis directions) by viewing the target 27 located on the virtual line B, outside the reflection mirror and in the casing 11 through the through-holes 19a and 19b provided in the light condensing reflection mirror 13a, and adjusting the position of the discharge lamp 12 so that the tip portion of the cathode 122 of the discharge lamp 12 overlaps with the second mark provided on the target 27.

Therefore, the variation in irradiance does not arise depending on an operator, and anyone can easily adjust the position of the discharge lamp 12, and further, it is possible to adjust the position of the discharge lamp 12 well when the light source apparatus 20 is installed in the case, or in a state where the light source apparatus 20 remains in the case 15 in case that the discharge lamp 12 shifts after the light source apparatus 20 is installed in the case 15. In addition, it is also possible to adjust the position of the discharge lamp 12 in the same manner, by forming a mark as shown in FIGS. 3A, 3B, and 3C to the target 17 shown in FIG. 1.

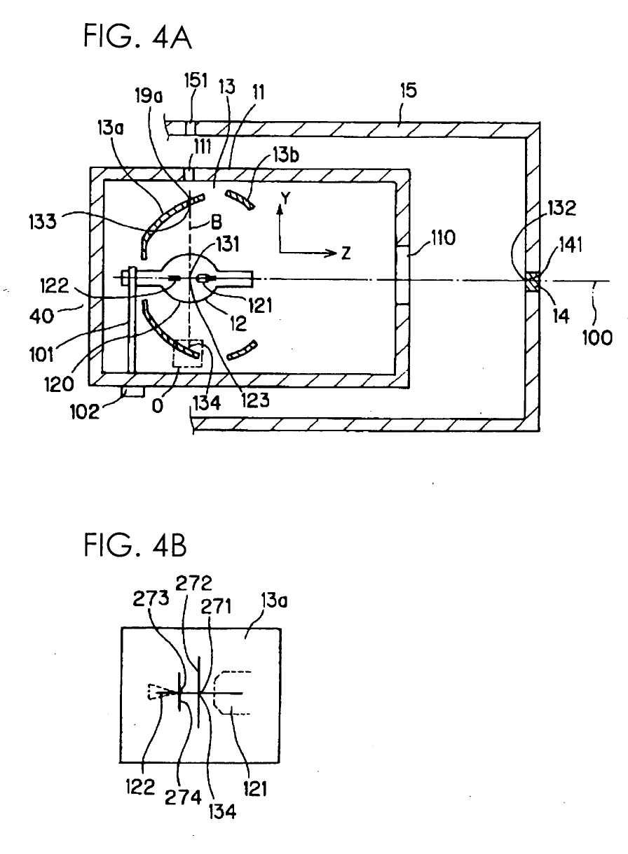

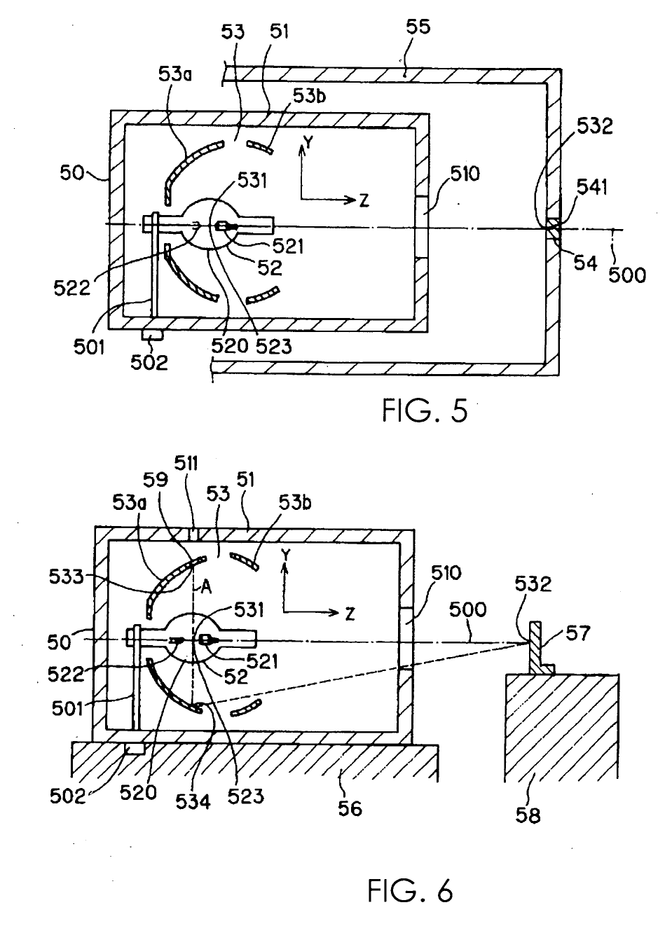

FIG. 4A is a cross sectional view of the structure in which a light source apparatus according to a third embodiment of the present invention is installed in a case to which an integrator lens is attached.

FIG. 4B is an enlarged view of the portion O shown in FIG. 4A, viewing in the direction of the Y axis.

In FIGS. 4A and 4B, the same reference character numbers as those of FIGS. 1 and 3 are assigned to the same elements as those shown in FIGS. 1A, 1B, 1C, 3A, 3B, and 3C.

In a light source apparatus 40, a structure thereof is the same as that of the light source apparatus 10 except that a target is directly provided on the light condensing reflection mirror 13a.

As shown in FIG. 4B, a mark 272 having a cross shape is formed on the other intersection portion 134 of the light condensing reflection mirror 13a by cutting with a tool etc. in the same manner as that of the target 27 shown in FIG. 3A.

In addition, although not illustrated, the same mark as that shown in FIG. 1C may be formed, and as long as there is no bad effect when light emitted from the discharge lamp 12 is condensed to the end 141 of the integrator lens 14, the mark may be formed in the same manner as that shown in FIGS. 3B and 3C.

As described above, according to the present invention, in the light source apparatus, since position adjustment of a discharge lamp is carried out by viewing, through a through hole(s) provided in a reflection mirror, a target for lamp position adjustment provided on a casing, no variation occurs depending on an operator, and further it is possible to adjust the position of the discharge lamp when the light source apparatus is installed in the case or in a state where the light source apparatus remains in the case even when the light source apparatus shifts after the light source apparatus is installed.

Thus the present invention possesses a number of advantages or purposes, and there is no requirement that every claim directed to that invention be limited to encompass all of them.

The disclosure of Japanese Patent Application No. 2003-369426 filed on Oct. 29, 2003 including specification, drawings and claims is incorporated herein by reference in its entirety.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

1. A light source apparatus having a discharge lamp, a reflection mirror, wherein the discharge lamp and the reflection mirror are disposed in a casing, and light emitted from the discharge lamp is condensed by the reflection mirror to an end portion of an integrator lens disposed outside the casing, the light source apparatus comprising:
a position adjustment unit in which position of the discharge lamp is adjusted so that a target for lamp position adjustment formed on the casing is seen on a virtual line which passes at least one through-hole for inspection provided in the reflection mirror and a portion where a luminescent spot of the discharge lamp is formed.

2. The light source apparatus according to claim 1, wherein the target is arranged so that an image of the target is projected on a portion where the virtual line crosses the reflection mirror.

3. The light source apparatus according to claim 1, wherein the target is provided on the virtual line.

4. The light source apparatus according to claim 1, wherein at least two or more through-holes are provided.

5. The light source apparatus according to claim 2, wherein at least two or more through-holes are provided.

6. The light source apparatus according to claim 1, wherein at least four or more through holes are provided.

7. The light source apparatus according to claim 2, wherein at least four or more through holes are provided.

8. The light source apparatus according to claim 3, wherein at least four or more through holes are provided.

9. A light source apparatus having a discharge lamp, a reflection mirror, wherein the discharge lamp and the reflection mirror are disposed in a casing, and light emitted from the discharge lamp is condensed by the reflection mirror to an end portion of an integrator lens disposed outside the casing, wherein a target for lamp position adjustment is provided on in the reflection mirror and at least one through hole for inspection is formed in the reflection mirror, and a position adjustment unit in which position of the discharge lamp is adjusted so that the target is seen on a virtual line is provided.

10. A projector comprising:
a light source apparatus, having a discharge lamp and a reflection mirror wherein at least one through hole for inspection is formed in the reflection mirror;
an integrator;
a casing;
wherein the discharge lamp and the reflection mirror are disposed in the casing, and light emitted from the discharge lamp is condensed by the reflection mirror to an end portion of the integrator lens disposed outside the casing;
a target for lamp position adjustment provided on the reflection mirror; and
a position adjustment unit in which position of the discharge lamp is determined by adjusting the discharge lamp so that the target is seen on a virtual line is provided.
